(19) United States
(12) Patent Application Publication
(10) Pub. No.: US 2019/0304044 A1
(43) Pub. Date: Oct. 3, 2019

(54) GOODS CARRYING METHOD, SERVER, CONSIGNEE TERMINAL AND CONSIGNOR TERMINAL

(71) Applicants: BEIJING BOE DISPLAY TECHNOLOGY CO., LTD., Beijing (CN); BOE TECHNOLOGY GROUP CO., LTD., Beijing (CN)

(72) Inventor: Yangchen GUO, Beijing (CN)

(21) Appl. No.: 16/182,063

(22) Filed: Nov. 6, 2018

(30) Foreign Application Priority Data
Mar. 30, 2018 (CN) 201810286679.3

(51) Int. Cl. G06Q 50/30; G06Q 10/08

(52) U.S. Cl. CPC G06Q 50/30; G06Q 10/083

(57) ABSTRACT

A goods carrying method, applicable to a passenger vehicle reservation server, which includes: receiving a goods carrying request sent by a goods carrying consignor terminal; sending the goods carrying request to passenger terminals that reserve a passenger vehicle; determining whether the request is received by the passenger terminal that reserves a passenger vehicle; when determining that the request is received by the passenger terminal that reserves the passenger vehicle, taking the passenger terminal that receives the request as a goods carrying consignee terminal, and establishing association between the goods carrying consignee terminal and the goods carrying consignor terminal; and delivering goods virtually between the goods carrying consignor terminal and the goods carrying consignee terminal on the basis of the association.

### CROSS-REFERENCE TO RELATED APPLICATION

The application claims priority to the Chinese patent application No. 201810286679.3, filed Mar. 30, 2018, the disclosure of which is incorporated herein by reference as part of the application.

### TECHNICAL FIELD

The embodiments of the present invention relates to a goods carrying method and a passenger vehicle reservation server, a consignee terminal, a consignor terminal and a computer-executable nonvolatile storage medium corresponding to the goods carrying method.

### BACKGROUND

At present, the application of network car is very extensive. Users can use the car app in the mobile phone terminal to reserve a network car. The driver can also select nearby passengers to make orders through the car network platform, which satisfies the need of people traveling in time.

However, the current passenger transportation network car application is separated from the freight network car application. The passenger vehicle network car is only for the passenger travel demand. Each passenger vehicle sometimes only carries one or two passengers, and the remaining space cannot be fully utilized, so the energy utilization is low.

### SUMMARY

According to at least one embodiment of this disclosure, a goods carrying method is provided, which is applicable to a passenger vehicle reservation server, the method comprises: receiving a goods carrying request sent by a goods carrying consignor terminal: sending the goods carrying request to passenger terminals that reserve a passenger vehicle; determining whether the request is received by a passenger terminal that reserves the passenger vehicle; when determining that the request is received by the passenger terminal that reserves the passenger vehicle, taking the passenger terminal that receives the request as a goods carrying consignee terminal, and establishing association between the goods carrying consignee terminal and the goods carrying consignor terminal; and delivering goods virtually between the goods carrying consignor terminal and the goods carrying consignee terminal on the basis of the association.

For example, sending the goods carrying request to the passenger terminals that reserve the passenger vehicle comprises: acquiring delivery place information and receipt place information of the goods; determining a first candidate vehicle set in the passenger vehicle reservation server, of which a starting place or a first route place is within a first predetermined distance from the delivery place, and a destination or a second route place is within a second predetermined distance from the receipt place, according to the delivery place information and the receipt place information; and sending the goods carrying request to passenger terminals of the first candidate vehicle set.

For example, sending the goods carrying request to the passenger terminals that reserve the passenger vehicle further comprises: acquiring delivery time information of the goods; determining a second candidate vehicle set in the first candidate vehicle set, wherein a candidate vehicle in the second candidate vehicle set is capable of arriving at the delivery place within the delivery time, according to the delivery time information and the delivery place information; and sending the goods carrying request to passenger terminals of the second candidate vehicle set.

For example, sending the goods carrying request to the passenger terminals that reserve the passenger vehicle further comprises: acquiring receipt time information of the goods; determining a third candidate vehicle set in the first candidate vehicle set or in the second candidate vehicle set, wherein a candidate vehicle in the third candidate vehicle set is capable of arriving at the receipt place within the receipt time, according to the receipt time information and receipt place information; and sending the goods carrying request to the passenger terminals of the third candidate vehicle set.

For example, taking the passenger terminal that receives the request as the goods carrying consignee terminal and establishing the association between the goods carrying consignee terminal and the goods carrying consignor terminal comprises: acquiring positioning information of the goods carrying consignor terminal and the goods carrying consignee terminal; sending the positioning information of the goods carrying consignor terminal to the goods carrying consignee terminal; and sending the positioning information of the goods carrying consignee terminal to the goods carrying consignor terminal; and wherein delivering the goods virtually between the goods carrying consignor terminal and the goods carrying consignee terminal on the basis of the association further comprises: delivering the goods virtually between the goods carrying consignor terminal and the goods carrying consignee terminal according to the positioning information.

For example, establishing the association between the goods carrying consignor terminal and the goods carrying consignee terminal further comprises: acquiring network communication identities of the goods carrying consignor terminal and the goods carrying consignee terminal; and establishing association between the network communication identity of the consignor terminal and the network communication identity of the goods carrying consignee terminal; and wherein delivering the goods between the consignor terminal and the goods carrying consignee terminal on the basis of the association further comprises: delivering the goods virtually between the consignor terminal and the goods carrying consignee terminal on the basis of the association between the network communication identities.

For example, delivering the goods virtually between the goods carrying consignor terminal and the goods carrying consignee terminal on the basis of the association further comprises: receiving a prompt that the vehicle arrives at a delivery place or a receipt place within a first predetermined time, sent by the goods carrying consignee terminal, on the basis of the association; and sending the prompt to the consignor terminal to prompt a user of the consignor terminal to arrive at the delivery place or the receipt place in time.

For example, after establishing the association between the goods carrying consignor terminal and the goods carrying consignee terminal, the method further comprises: determining whether the journey of the vehicle begins; sending a request of handover before journey to the goods carrying consignee terminal according to a request of the consignor terminal when determining that the journey of the vehicle does not begin; and receiving a reply to the request of handover before journey by the goods carrying consignee terminal; wherein delivering the goods virtually between the goods carrying consignor terminal and the goods carrying consignee terminal on the basis of the association comprises: allowing the goods carrying consignor terminal and the goods carrying consignee terminal to hand over the goods before the journey begins according to the request of handover before journey and the reply.

According to at least one embodiment of this disclosure, a goods carrying method is provided, which is applicable to a goods carrying consignee terminal, the method comprises: acquiring at least one goods carrying request through a passenger vehicle reservation server; selecting and receiving a goods carrying request from the at least one goods carrying request; receiving association information sent by the passenger vehicle reservation server, through the association information, association between the goods carrying consignee terminal and a goods carrying consignor terminal sending the goods carrying request is established; and delivering goods virtually with the goods carrying consignor terminal sending the goods carrying request on the basis of the association information.

For example, the consignee terminal comprises at least one passenger terminal that reserves passenger vehicles.

For example, delivering the goods virtually with the consignor terminal sending the goods carrying request on a basis of the association information comprises: determining a time of arriving at a delivery place of the vehicle according to vehicle speed of the vehicle and the delivery place information; and sending prompt information to the consignor terminal when the time is within a first predetermined range.

For example, goods transportation is canceled when the consignee terminal arrives at the delivery place at an agreed delivery time, but the consignor terminal does not arrive at the delivery place within a second predetermined time from the delivery time.

For example, after establishing the association with the consignor terminal of the goods carrying request, the method further comprises: setting a route of a navigation system of the vehicle as passing through a delivery place and/or a receipt place.

For example, the method comprises: sending a handover completion message to a passenger vehicle reservation server after goods handover is completed; and/or sending the handover completion message to the goods carrying consignor terminal after goods handover is completed.

According to at least one embodiment of this disclosure, a goods carrying method is provided, which is applicable to a goods carrying consignor terminal, the method comprises: sending at least one goods carrying request to a passenger vehicle reservation server; receiving a reply message to the goods carrying request from the passenger vehicle reservation server, and the reply message includes information of a consignee terminal that receives the goods carrying request; receiving association information sent by the passenger vehicle reservation server, through the association information, association between the goods carrying consignor terminal and the goods carrying consignee terminal that receives the goods carrying request is established; and delivering goods virtually with the consignee terminal of the goods carrying request on the basis of the association information.

According to at least one embodiment of this disclosure, a passenger vehicle reservation server is provided, which comprises: a memory and a processor, wherein, the memory stores instructions, when the processor loads and executes the instruction, the goods carrying method above are executed.

According to at least one embodiment of this disclosure, a goods carrying consignee terminal is provided, which comprises: a memory and a processor, wherein, the memory stores instructions, when the processor loads and executes the instruction, the goods carrying method above are executed.

According to at least one embodiment of this disclosure, a goods carrying consignor terminal is provided, which comprises: a memory and a processor, wherein, the memory stores instructions, when the processor loads and executes the instruction, the goods carrying method above is executed.

According to at least one embodiment of this disclosure, a computer-executable nonvolatile storage medium is provided, which stores computer program instructions, when a processor of a computer loads and executes the instructions, the goods carrying method above are executed.

### BRIEF DESCRIPTION OF THE DRAWINGS

In order to more clearly illustrate the technical proposals of the embodiments of the present invention, the drawings to be used in the description of the embodiments will be briefly described below. Obviously, the drawings described below are merely the preferred embodiments of the present invention.

FIG. 1 is a goods carrying method applied to a passenger vehicle reservation server provided by the embodiments of the present invention;

FIG. 2 is a goods carrying method applied to a goods carrying consignee terminal provided by the embodiments of the present invention;

FIG. 3 is a goods carrying method applied to a goods carrying consignor terminal provided by the embodiments of the present invention;

FIG. 4 is a schematic structural view of a passenger vehicle reservation server provided by the embodiments of the present invention;

FIG. 5 is a schematic structural view of a goods carrying consignee terminal provided by the embodiments of the present invention;

FIG. 6 is a schematic structural view of a goods carrying consignor terminal provided by the embodiments of the present invention; and

FIG. 7 is an architecture diagram of goods carrying provided by the embodiments of the present invention.

### DETAILED DESCRIPTION

Detailed description will be given below to the preferred embodiments of the present invention with reference to the accompanying drawings. It should be noted that in the description and the drawings, substantially the same steps and elements are represented by the same reference numerals, and the repeated explanation of these steps and elements will be omitted.

In the embodiments of the present invention, the passenger vehicle reservation server is, for example, a network ride-hailing platform for passenger vehicles, and manages a ride-hailing network for passenger vehicles. A passenger terminal that needs to reserve a passenger vehicle can reserve a passenger vehicle through the network ride-hailing platform, and a driver terminal of a vehicle that provides passenger service can know passengers who need to take passenger vehicles through the network ride-hailing platform and associate with the passenger. In the embodiments of the present invention, the goods carrying consignor terminal is, for example, a user terminal that needs to entrust another person to carry goods. The goods carrying consignee terminal is, for example, a user terminal that is entrusted by a consignor to assist the consignor in carrying the goods. The above two terminals, for instance, may be mobile phone terminals, computer terminals, etc.

The goods carrying consignor terminal may include a user terminal that delivers goods, and may also include a receiver terminal that receives the delivered goods. The goods carrying consignee terminal may include a passenger terminal that reserves a passenger vehicle and has or is about to take the reserved passenger vehicle. In the embodiments of the present invention, the reserved vehicle may be a taxi, a special car, a ride sharing or the like that can make a reservation through a network platform. For example, the handover of goods is the virtual transfer of goods between the goods carrying consignor terminal and the goods carrying consignee terminal. The virtual transfer of the goods is relevant to the real transfer of the goods. For example, the handover includes delivery handover, and also includes receipt handover. In addition, the handover of goods may be the transfer of goods between people, and may also be that the consignee takes the goods placed in a certain place (such as a locker) by the consignor or places the goods in a place (such as a receiving container) specified by the consignor.

The passenger vehicle reservation server, the goods carrying consignee terminal and the goods carrying consignor terminal may be communicated with each other by wired or wireless network. The wired network is, for instance, a wired local area network (LAN), a wide area network (WAN) or a wired telephone communication network. The wireless network, for example, may be a wireless local area network (WLAN), a Telecom mobile network, etc.

In addition, in the embodiments of the present invention, the reserved vehicle refers to a vehicle that has been successfully reserved by a passenger but has not departed from the reserved starting point, or has started from the reserved starting point but has not arrived at the reserved destination. Vehicles that have not made a successful reservation, or have been successfully reserved but have completed the entire journey of the reservation order are not within the discussion scope of the present invention.

FIG. 7 is an architecture diagram of goods carrying in the embodiments of the present invention. As shown in FIG. 7, a goods carrying consignee terminal 710 is in signal connection with a passenger vehicle reservation server 720; similarly, a goods carrying consignor terminal 730 is in signal connection with the passenger vehicle reservation server 720; and the goods carrying consignee terminal 710 and the goods carrying consignor terminal 730 are associated and communicated with each other through the passenger vehicle reservation server 720. According to one example of the present invention, there are a plurality of goods carrying consignor terminals 730 and a plurality of goods carrying consignee terminals 710, and they are respectively in signal connection with the passenger vehicle reservation server 720 to constitute a passenger vehicle reservation network.

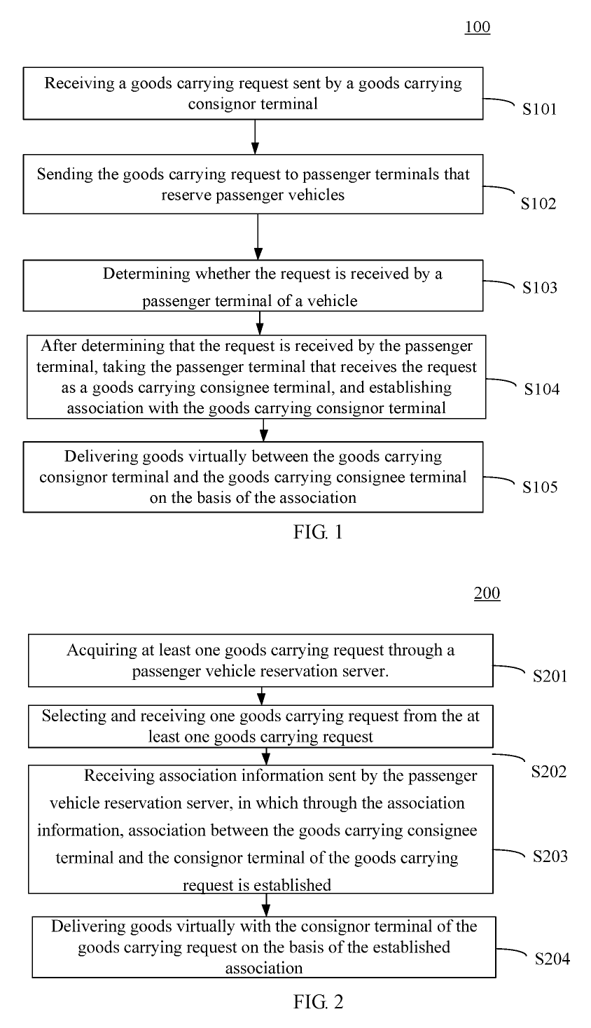

FIG. 1 illustrates a goods carrying method applied to a passenger vehicle reservation server, provided by the embodiments of the present invention. As shown in FIG. 1, the goods carrying method 100 comprises the following steps S101-S105.

S101: receiving a goods carrying request sent by a goods carrying consignor terminal. According to one example of the present invention, the passenger vehicle reservation server always monitor whether there is a goods carrying request sent by the goods carrying consignor terminal, and moreover, receives the goods carrying request when monitoring there is a goods carrying request.

The goods carrying request may include one or more of the following information: sender identifying information, sender network identity information, sender contact number; receiver identifying information, receiver network identity information, receiver contact number; delivery time information, delivery place information, receipt time information, receipt place information; the attribute information of goods to be sent, etc. The goods attribute information, for instance, includes the type of the goods, the weight of the goods, etc.

Relevant information of the sender and relevant information of the receiver may also be filled in when the sender or the receiver registers in the passenger vehicle reservation server in advance. When the sender sends the goods carrying request, the passenger vehicle reservation server can automatically acquire the relevant information of the sender and the relevant information of the receiver.

In addition, the goods carrying request may further include special demands of the consignor terminal, for example, whether to hand over the goods before the vehicle departs from the starting place, whether insurance is required, and the space and the time required for goods transportation.

S102: sending the goods carrying request to passenger terminals that reserve passenger vehicles. According to one example of the present invention, after the passenger vehicle reservation server receives the goods carrying request, the goods carrying request may be sent to all the passenger terminals that have reserved the passenger vehicles in the passenger vehicle reservation network managed by the passenger vehicle reservation server, and whether to receive the goods carrying request is selected by the passenger. Or the passenger vehicle reservation server automatically selects partial passenger terminals from all the passenger terminals that have reserved the vehicles, and sends the goods carrying request to this part of passenger terminals.

For instance, the passenger vehicle reservation server may acquire departure place information and receipt place information of the goods from the goods carrying request, and subsequently, selects from the passenger terminals that have reserved the vehicles in the passenger vehicle reservation network according to the delivery place information and the receipt place information, and determines vehicles as a first candidate vehicle set if the starting place or the first route place of the vehicle reserved by the passenger terminal is within the first predetermined distance from the delivery place and the destination or the second route place is within the second predetermined distance from the receipt place. The first predetermined distance range and the second predetermined distance range may be preset, for instance, within 5 km range, within 2 km range or within 1 km range, as long as the distance range is relatively close to the vehicle, and the distance that requires the vehicle to consume too much energy is not needed. Of course, the predetermined distance range may also be set by the reservation passenger terminal. If the passenger does not care about the distance and wants to be able to change the way to help carrying the goods, the passenger can set a distance range at any time as required that the passenger can accept or set completely no distance range limit.

After determining the above first candidate vehicle set that satisfies the conditions, the passenger vehicle reservation server can send the goods carrying request to the passenger terminals of the first candidate vehicle set in real time.

In the example, the goods carrying request is sent to partial passenger terminals that are selected according to the delivery place and the receipt place information, so vehicles close to the delivery place and the receipt place, namely, ride-hitching vehicles, can be find out: In this case, it will not waste the reservation passengers too much time. Meanwhile, the reserved vehicle can deliver the goods on the way without consuming too much energy.

On the basis of the above example, according to another example of the present invention, the passenger vehicle reservation server may further acquire delivery time information of the goods, and subsequently, determine vehicles in the foregoing first candidate vehicle set, capable of arriving at the delivery place within the delivery time, according to the delivery place information and the delivery place information, and determine these vehicles as a second candidate vehicle set, and send the goods carrying request to passenger terminals of the second candidate vehicle set. That is to say, if the sender needs to hand over the goods with a passenger that reserves a vehicle within specific time or time period, delivery time information may be added into the goods carrying request. The passenger vehicle reservation server can determine vehicles in the first candidate vehicle set, capable of arriving at the delivery place within the time, according to the delivery time information, and only send the goods carrying request to the vehicles capable of arriving at the delivery place within the delivery time. In the process of selecting the second candidate vehicle set from the first candidate vehicle set, whether the vehicle can arrive at the delivery place within the delivery time may also be estimated according to the current position of the first candidate vehicle set and the indicators such as the performance and the speed.

The example can further select vehicles that can meet the delivery time requirement of the sender, can further save the time of goods handover of the two parties, and further satisfy the user demands.

On the basis of the foregoing two examples, according to another example of the present invention, the passenger vehicle reservation server may further acquire delivery time information of the goods, determine a third candidate vehicle set in the first candidate vehicle set or the second candidate vehicle set, capable of arriving at the delivery place within the delivery time, according to the delivery time information and the delivery place information. And subsequently, send the goods carrying request to passenger terminals of the third candidate vehicle set. For instance, when the sender or the receiver requires that the goods need to be delivered urgently at the specified time, the passenger vehicle reservation server can determine vehicles in the first candidate vehicle set or the second candidate vehicle set, capable of arriving at the delivery place at the specified delivery time, according to the current position and the performance of the vehicles, and determine these vehicles as the third candidate vehicle set, so as to further accurately determine service vehicles and satisfy the customer needs.

S103: determining whether the request is received by a passenger terminal of a vehicle. After sending the goods carrying request in the passenger vehicle reservation network, the passenger vehicle reservation server monitors whether there is a passenger terminal that reserves a passenger vehicle responding to the request. When a plurality of passenger terminals respond to the request, one passenger terminal may be selected from the plurality of passenger terminals and taken as the final passenger terminal for receiving the request. For instance, a passenger terminal that responds the fastest is selected from the plurality of responsive passenger terminals and taken as the passenger terminal for receiving the request. Moreover, for instance, one passenger terminal that is most suitable to receive the goods carrying request may also be selected according to position information of the vehicle reserved by the passenger terminal or the starting place and the destination of the reservation order.

S104: after determining that the request is received by the passenger terminal, taking the passenger terminal that receives the request as a goods carrying consignee terminal, and establishing association with the goods carrying consignor terminal. According to one example of the present invention, the passenger vehicle reservation server respectively acquires positioning information of the goods carrying consignor terminal and the goods carrying consignee terminal, and subsequently, respectively sends the positioning information of the goods carrying consignor terminal to the goods carrying consignee terminal and sends the positioning information of the goods carrying consignee terminal to the goods carrying consignor terminal, according to identification information of the goods carrying consignor terminal and identification information of the goods carrying consignee terminal, so that the two can be associated and can understand the real-time location of the other party according to the positioning information of the other party, and determine whether the other party arrives at the delivery place or the receipt place according to the real-time location information.

According to another example of the present invention, the passenger vehicle reservation server may also acquire a network communication identity of the consignor terminal from the goods carrying request or consignor registration information, and acquire a network communication identity of the passenger terminal from network registration information of the goods carrying consignee terminal. The two network communication identities are associated. For instance, instant messaging identification information of the two terminals is acquired, and instant messaging identities of the two terminals are associated. For instance, an associating window is created so that the two terminals can implement instant messaging on the basis of the associating window, for example, sending text messages through a chat window.

According to another example of the present invention, the passenger vehicle reservation server may also acquire telephone information of the consignor terminal or telephone information of the consignee terminal from user registration information, and subsequently, send the telephone information of the consignor terminal to the goods carrying consignee terminal and send the telephone information of the goods carrying consignee terminal to the consignor terminal, so that the two can communicate on mobile phones.

According to one example of the present invention, various above association methods can be combined arbitrarily. For instance, the passenger vehicle reservation server can send the positioning information, the network communication identification information and the telephone information of the consignor terminal to the consignee terminal and send the positioning information, the network communication identification information and the telephone information of the consignee terminal to the consignor terminal, so that the two can associate with each other on the basis of various kinds of above information.

S105: delivering goods virtually between the goods carrying consignor terminal and the goods carrying consignee terminal on the basis of the association. For instance, when the consignor terminal and the goods carrying consignee terminal are associated according to the positioning information in the step S104, in the step S105, the passenger vehicle reservation server allows the consignor terminal and the goods carrying consignee terminal to hand over the goods according to the positioning information. For instance, the consignor terminal and the goods carrying consignee terminal can know the real-time position of the other party according to the positioning information of the other party, determine whether the other party arrives at the delivery place or the receipt place according to the real-time position information, and hands over the goods. In the embodiments of this disclosure, the handover includes a virtual transfer of the goods between the goods carrying consignor terminal and the goods carrying consignee terminal. For example, the virtual transfer is an electronic transfer based on an Application installed on the terminals. The virtual transfer of the goods is relevant to a real transfer. For example, a goods carrying consignor terminal and a goods carrying consignee terminal are installed a goods transfer application program respectively. In the process of goods transfer, after finishing the real transfer between the user (or his or her consignor) of the consignor terminal and the user (or his or her consignor) of the consignee terminal, the user of the consignee terminal press a button of “Goods transfer succeed” on a user interface of the application, so as to send a message of goods transfer successfully to the consignor terminal and the passenger vehicle reservation server to indicate that receiving the goods or delivering the goods successfully. Then the electronic transfer of goods is finished. If the user (or his or her consignor) of the consignee terminal does not receive or cannot deliver the goods of the user (or his or her consignor) of the consignor terminal, then the user of the consignee terminal press a button of “Goods transfer failed” on the user interface of the application, so as to send a message of goods transfer unsuccessfully to the consignor terminal and the passenger vehicle reservation server, to indicate receiving the goods or delivering the goods unsuccessfully. Now the process of electronic delivery of this time may be finished.

Or when the consignor terminal and the goods carrying consignee terminal are associated according to the network communication identities in the step S104, the passenger vehicle reservation server allows the consignor terminal and the goods carrying consignee terminal to hand over the goods according to the network communication identities. For instance, the consignor terminal and the goods carrying consignee terminal can determine the specific matters of goods handover by instant information communication based on the network communication identities or by telephone call based on the telephone information.

According to one example of the present invention, after the association is established between the consignor terminal and the goods carrying consignee terminal, communication information or positioning information between the consignor terminal and the goods carrying consignee terminal may also be transferred through the passenger vehicle reservation server. For instance, the passenger vehicle reservation server may receive a prompt that the vehicle arrives at the delivery place, sent by the goods carrying consignee terminal that reserves the vehicle, and send the prompt to the consignor terminal to prompt a user of the consignor terminal to arrive at the delivery place on time. Similarly, the consignor terminal may also send information of arriving at the delivery place, and the passenger vehicle reservation server may transfer the information to the goods carrying consignee terminal, so that the goods carrying consignee terminal can know the situation. Thus, the server can know the handover situation between the consignor terminal and the goods carrying consignee terminal in real time, so as to provide effective supervision.

In addition, according to one example of the present invention, the consignor terminal and the goods carrying consignee terminal may also hand over the goods in advance before the vehicle departs. After the consignor terminal and the goods carrying consignee terminal establish the association the passenger vehicle reservation server may further determine whether the vehicle's journey begins, for instance, determining whether the vehicle departs from the starting place based on the request of the consignor or based on the default entrustment process. When it is determined that the journey does not begin, a request of delivering the goods before the journey may be sent to the goods carrying consignee terminal on the basis of the request of the consignor terminal. When it is determined that the journey has begun, the request of delivering the goods before the journey may be not sent to the goods carrying consignee terminal again. After receiving a reply of the goods carrying consignee terminal to the request of delivering the goods before the journey, the consignor terminal and the goods carrying consignee terminal may hand over the goods before the journey. For instance, when there is a predetermined time from the departure of the vehicle, the consignor terminal and the goods carrying consignee terminal can hand over the goods by arriving at the delivery place in advance through network communication or mutual positioning information, and the goods carrying consignee terminal goes to the reserved vehicle after taking the handover goods, thereby the situation that the vehicle makes a detour to picks up the goods after the start of the journey is avoided and the energy consumption of the vehicle is saved.

Of course, the consignor terminal may also take the request of delivering the goods before the departure of the vehicle as one part of the foregoing goods carrying request, and send to the passenger vehicle reservation server. Thus, the vehicle reservation server can push the request to the goods carrying consignee terminal after receiving the goods carrying request, and the goods carrying consignee terminal determines whether it can hand over the goods before the vehicle departs, and then chooses whether to accept the request to hand over the goods.

In addition, according to one example of the present invention, when the goods carrying consignee terminal successfully completes the handover of goods during the ride and delivers the goods to the receiver specified by the consignor terminal, it can send a handover completion message to the consignor terminal, and can also send the handover completion message to the passenger vehicle reservation server. The passenger vehicle reservation server may request the goods consignor terminal to pay the fee according to the handover completion message, and forward one part of the fee to the entrusted goods carrying consignee terminal and/or the driver terminal of the vehicle, and finish this passenger vehicle goods carrying task.

In the embodiments of the present invention, by carrying goods on the road through the passenger vehicles, it is possible to effectively use the vehicles on the way to carry the goods. Thus, the vehicle space can be fully utilized; the energy can be saved; and the user needs can be also met.

Description has been given above to the goods carrying method applied to the passenger vehicle reservation server provided by the embodiments of the present invention. Further description will be given below to the goods carrying method applied to the goods carrying consignee terminal provided by the embodiments of the present invention. The method corresponds to the method provided by the foregoing embodiments. For the sake of brevity of the description, only brief description is given below. For details, refer to the goods carrying method provided by the foregoing embodiments.

FIG. 2 illustrates the goods carrying method applied to the goods carrying consignee terminal provided by the embodiment of the present invention. In the embodiments of the present invention, the consignee terminal includes at least one passenger terminal that reserves a passenger vehicle. Of course, the consignee terminal may also be a driver terminal of a reserved passenger vehicle.

As shown in FIG. 2, the goods carrying method 200 applied to the goods carrying consignee terminal comprises the steps S201-S204.

S201: acquiring at least one goods carrying request through a passenger vehicle reservation server. According to one example of the present invention, the goods carrying consignee terminal is connected with the passenger vehicle reservation server. The goods carrying consignee terminal may monitor broadcast messages pushed by the passenger vehicle reservation server. The broadcast message broadcasts one or more goods carrying requests.

S202: selecting and receiving one goods carrying request from the at least one goods carrying request. According to one example of the present invention, the goods carrying consignee terminal may receive at least one goods carrying request from the passenger vehicle reservation server according to a passenger instruction, for example, an instruction of the terminal user.

S203: receiving association information sent by the passenger vehicle reservation server, in which through the association information, association between the goods carrying consignee terminal and the consignor terminal of the goods carrying request is established. According to one example of the present invention, after receiving one goods carrying request, the association between the consignee terminal of the goods carrying request and the consignor terminal of the goods carrying request is established. For instance, positioning information, network identity information and/or Telecom network communication number of the other party are acquired through the passenger vehicle reservation server, and the association is established through the information.

In addition, according to one example of the present invention, after establishing a connection with the consignor terminal of the goods carrying request, the goods carrying consignee terminal may also send an instruction to a vehicle terminal of a reserved vehicle, and the vehicle terminal may set the route of a navigation system of the vehicle as passing through the delivery place and/or the receipt place, so as to provide convenience for the vehicle to arrive at the delivery place and/or the receipt place. For instance, a network ride-hailing application in the goods carrying consignee terminal sends an instruction signal to a navigation application in the goods carrying consignee terminal, and the route of the navigation system of the vehicle is set to pass through the delivery place and/or the receipt place. Moreover, for instance, the goods carrying consignee terminal may also send the delivery place and/or the receipt place to the driver terminal or the vehicle terminal of the reserved vehicle through the passenger vehicle reservation server, and the navigation system of the vehicle terminal or the driver terminal is directly set to pass through the delivery place and/or the receipt place. Moreover, for instance, after determining a connection is established between the goods carrying consignee terminal and the goods carrying consignor terminal, the passenger vehicle reservation server may directly send delivery place and/or receipt place information in the carrying request of the goods carrying consignor terminal to the vehicle terminal of the reserved vehicle, and the vehicle terminal may indicate the navigation system to set a navigation route that passes through the delivery place and/or the receipt place.

S204: delivering goods virtually with the consignor terminal of the goods carrying request on the basis of the established association. In the embodiments of this disclosure, the handover includes a virtual transfer of the goods between the goods carrying consignor terminal and the goods carrying consignee terminal. For example, the virtual transfer is an electronic transfer based on an Application installed on the terminals. The virtual transfer of the goods is relevant to a real transfer. For example, a goods carrying consignor terminal and a goods carrying consignee terminal are installed a goods transfer application program respectively. In the process of goods transfer, after finishing the real transfer between the user (or his or her consignor) of the consignor terminal and the user (or his or her consignor) of the consignee terminal, the user of the consignee terminal press a button of “Goods transfer succeed” on a user interface of the application, so as to send a message of goods transfer successfully to the consignor terminal and the passenger vehicle reservation server to indicate that receiving the goods or delivering the goods successfully. Then the electronic transfer of goods is finished. If the user (or his or her consignor) of the consignee terminal does not receive or cannot deliver the goods of the user(or his or her consignor) of the consignor terminal, then the user of the consignee terminal press a button of “Goods transfer failed” on the user interface of the application, so as to send a message of goods transfer unsuccessfully to the consignor terminal and the passenger vehicle reservation server, to indicate receiving the goods or delivering the goods unsuccessfully. Now the process of electronic delivery of this time may be finished.

For instance, the goods carrying consignee terminal may determine the time of arriving at the delivery place of the vehicle according to the speed of the vehicle and the delivery place information, and inform the estimated arrival time to the sender in real time; or send prompt information to the consignor terminal when the time is determined to be within the first predetermined time range. For instance, when the vehicle is about to arrive at the delivery place within 10 minutes, the prompt information may be sent to the consignor terminal to prompt the consignor terminal to arrive at the delivery place in time for goods handover, so as to avoid the consignee from waiting too much time and affecting the journey. Similarly, the goods carrying consignee terminal may determine the time of arriving at the receipt place of the vehicle according to the speed of the vehicle and the delivery place information, and inform the estimated arrival time to the receiver in real time, or may also send prompt information to the receiver when determining that the time is within the first predetermined time range.

According to another example of the present invention, the operation of sending the prompt information to the consignor terminal is executed by the passenger vehicle reservation server. For instance, the passenger vehicle reservation server monitors the implementation status of the goods carrying order in real time, for instance, determining position information of the reserved vehicle and the consignor terminal in real time, determining the time that the reserved vehicle may arrive at the delivery place according to the position information of the reserved vehicle, and inform the estimated arrival time to the sender in real time; or send prompt information to the consignor terminal when determining that the arrival time is within the first predetermined time range. Similarly, the passenger vehicle reservation server may also send the position information of the consignor terminal, taken as prompt information, to the passenger terminal.

In addition, according to one example of the present invention, when the consignee terminal arrives at the delivery place at the agreed delivery time, but the user of the consignor terminal has not arrived, at this point, the consignee terminal may determine whether the consignor can arrive at the delivery place within the second predetermined time range from the delivery time. The second predetermined time range is, for instance, within 5 minutes or within 20 minutes. If the consignor terminal cannot arrive at the delivery place within the second predetermined time, in order to prevent the consignee from waiting too much time, the consignee terminal may cancel the goods transportation task. After canceling the goods transportation task, the consignee terminal may also inform the passenger vehicle reservation server that the task has been canceled.

According to one example of the present invention, after goods handover is completed, the goods carrying consignee terminal sends a handover completion message to the passenger vehicle reservation network server. In addition, after the completion of goods handover, the goods carrying consignee terminal may also send the handover completion message to the consignor terminal.

The goods carrying consignee terminal in the embodiments of the present invention can receive the request of carrying the goods on the way from the passenger vehicle reservation server and carry the goods on the way, thereby satisfying the user demand and meanwhile, realizing energy saving and emission reduction of vehicles.

Description is given above to the goods carrying method applied to the goods carrying consignee terminal provided by the embodiments of the present invention. Further description will be given below to the goods carrying method applied to the goods carrying consignor terminal. The method corresponds to the method provided by the foregoing embodiments. The specific content may refer to the plurality of foregoing embodiments.

FIG. 3 illustrates a goods carrying method 300 applied to the goods carrying consignor terminal provided by the embodiments of the present invention. As shown in FIG. 3, the method comprises the steps S301-S304.

S301: sending at least one goods carrying request to a passenger vehicle reservation server.

S302: receiving a reply message to the goods carrying request from the passenger vehicle reservation server, in which the reply message includes information of a consignee terminal that receives the goods carrying request. According to one example of the present invention, when the request is received by a terminal, the goods carrying consignor terminal may receive information of the consignee terminal that receives the request from the passenger vehicle reservation server. When no terminal receives the goods carrying request, a feedback message that nobody replies may also be received from the passenger vehicle reservation server.

S303: receiving association information sent by the passenger vehicle reservation server, in which through the association information, association is established between the goods carrying consignor terminal and the consignee terminal that receives the goods carrying request.

S304: delivering goods virtually with the consignee terminal of the goods carrying request on the basis of the association. In the embodiments of this disclosure, the handover includes a virtual transfer of the goods between the goods carrying consignor terminal and the goods carrying consignee terminal. For example, the virtual transfer is an electronic transfer based on an Application installed on the terminals. The virtual transfer of the goods is relevant to a real transfer. For example, a goods carrying consignor terminal and a goods carrying consignee terminal are installed a goods transfer application program respectively. In the process of goods transfer, after finishing the real transfer between the user (or his or her consignor) of the consignor terminal and the user (or his or her consignor) of the consignee terminal, the user of the consignee terminal press a button of “Goods transfer succeed” on a user interface of the application, so as to send a message of goods transfer successfully to the consignor terminal and the passenger vehicle reservation server to indicate that receiving the goods or delivering the goods successfully. Then the electronic transfer of goods is finished. If the user (or his or her consignor) of the consignee terminal does not receive or cannot deliver the goods of the user (or his or her consignor) of the consignor terminal, then the user of the consignee terminal press a button of “Goods transfer failed” on the user interface of the application, so as to send a message of goods transfer unsuccessfully to the consignor terminal and the passenger vehicle reservation server, to indicate receiving the goods or delivering the goods unsuccessfully. Now the process of electronic delivery of this time may be finished.

The goods carrying consignor terminal provided by the embodiments of the present invention can entrust the passenger that reverses the passenger vehicle to carry the goods on the way through the passenger vehicle reservation server, thus enriching the way of goods transportation and making full use of energy.

Further description will be given below to hardware corresponding to the foregoing method. For the sake of brevity of the description, only brief description will be given below.

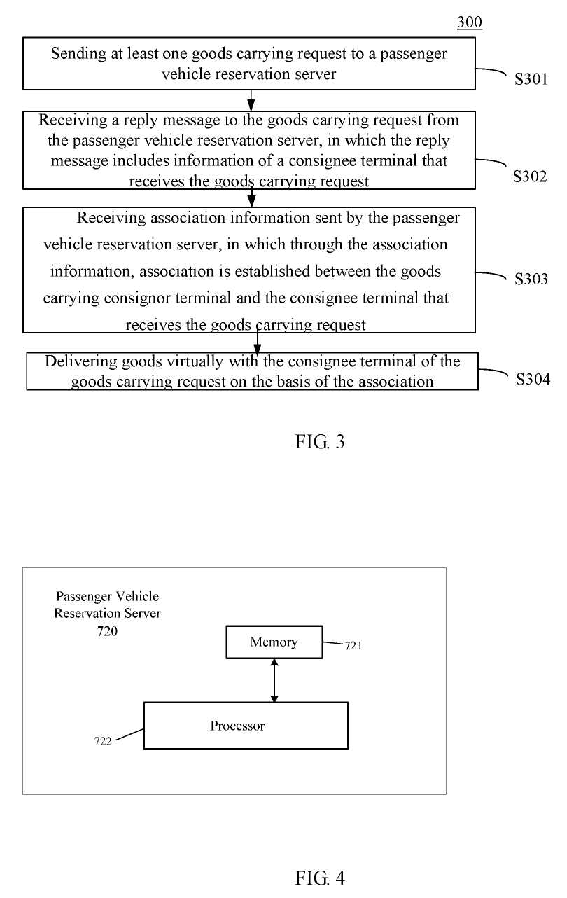

FIG. 4 is a schematic structural view of a passenger vehicle reservation server provided by the embodiments of the present invention. As shown in FIG. 4, the passenger vehicle reservation server 720 comprises a memory 721 and a processor 722. The memory 721 stores instructions. When the processor 722 loads and executes the instruction, the goods carrying method applied to the passenger vehicle reservation server, provided by the foregoing embodiments, is executed.

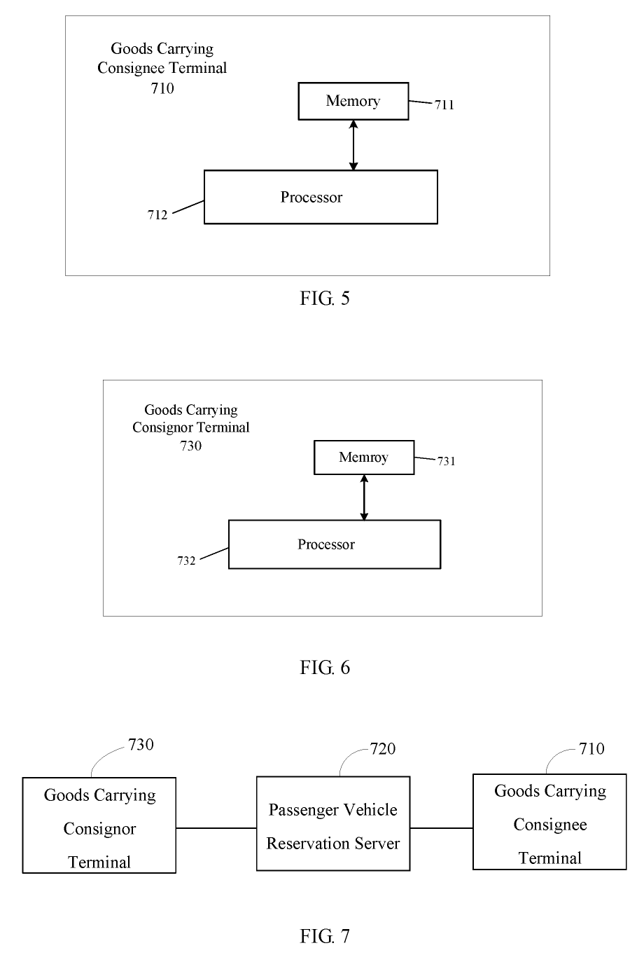

FIG. 5 is a schematic structural view of a goods carrying consignee terminal provided by the embodiments of the present invention. As shown in FIG. 5, the goods carrying consignee terminal 710 comprises a memory 711 and a processor 712. The memory 711 stores instructions. When the processor 712 loads and executes the instruction, the goods carrying method applied to the goods carrying consignee terminal, provided by the foregoing embodiment, is executed.

FIG. 6 is a schematic structural view of a goods carrying consignor terminal provided by the embodiments of the present invention. As shown in FIG. 6, the goods carrying consignor terminal 730 comprises a memory 731 and a processor 732. The memory 731 stores instructions. When the processor 732 loads and executes the instruction, the goods carrying method applied to the goods carrying consignor terminal, provided by the foregoing embodiment, is executed.

In addition, the embodiments of the present invention further provide a computer-executable nonvolatile storage medium which stores computer program instructions. When a processor of a computer loads and executes the instruction, the goods carrying method applied to the passenger vehicle reservation server, provided by the foregoing embodiments, is executed.

The processor in the above embodiments may be a general purpose processor such as a central processing unit (CPU), and may also be an specific processor such as a programmable logic circuit.

It should be appreciated by those skilled in the art that the elements and algorithm steps of the examples described in connection with the embodiments disclosed herein can be implemented in electronic hardware, computer software, or a combination of both. And the software module can be placed in any form of computer storage medium. In order to clearly illustrate the interchangeability of hardware and software, the composition and the steps of the examples have been generally described in terms of functionality in the foregoing description. Whether these functions are implemented in hardware or software depends on the specific application of the technical proposal and the design constraints. Different methods can be used by those skilled in the art to implement the described functions for each particular application, but such implementation should not be considered to be beyond the scope of the present invention.

It should be understood by those skilled in the art that various modifications, combinations, partial combinations and replacements of the present invention may be made according to design demands and other factors without departing from the scope of the appended claims and the equivalents thereof.

What is claimed is:

1. A goods carrying method, applicable to a passenger vehicle reservation server, comprising:
receiving a goods carrying request sent by a goods carrying consignor terminal;
sending the goods carrying request to passenger terminals that reserve a passenger vehicle;
determining whether the request is received by a passenger terminal that reserves the passenger vehicle;
when determining that the request is received by the passenger terminal that reserves the passenger vehicle, taking the passenger terminal that receives the request as a goods carrying consignee terminal, and establishing association between the goods carrying consignee terminal and the goods carrying consignor terminal; and
delivering goods virtually between the goods carrying consignor terminal and the goods carrying consignee terminal on the basis of the association.

2. The method according to claim 1, wherein sending the goods carrying request to the passenger terminals that reserve the passenger vehicle comprises:
acquiring delivery place information and receipt place information of the goods;
determining a first candidate vehicle set in the passenger vehicle reservation server, of which a starting place or a first route place is within a first predetermined distance from the delivery place, and a destination or a second route place is within a second predetermined distance from the receipt place, according to the delivery place information and the receipt place information; and
sending the goods carrying request to passenger terminals of the first candidate vehicle set.

3. The method according to claim 2, wherein sending the goods carrying request to the passenger terminals that reserve the passenger vehicle further comprises:
acquiring delivery time information of the goods;
determining a second candidate vehicle set in the first candidate vehicle set, wherein a candidate vehicle in the second candidate vehicle set is capable of arriving at the delivery place within the delivery time, according to the delivery time information and the delivery place information; and
sending the goods carrying request to passenger terminals of the second candidate vehicle set.

4. The method according to claim 3, wherein sending the goods carrying request to the passenger terminals that reserve the passenger vehicle further comprises:
acquiring receipt time information of the goods;
determining a third candidate vehicle set in the first candidate vehicle set or in the second candidate vehicle set, wherein a candidate vehicle in the third candidate vehicle set is capable of arriving at the receipt place within the receipt time, according to the receipt time information and receipt place information; and
sending the goods carrying request to the passenger terminals of the third candidate vehicle set.

5. The method according to claim 1, wherein taking the passenger terminal that receives the request as the goods carrying consignee terminal and establishing the association between the goods carrying consignee terminal and the goods carrying consignor terminal comprises:
acquiring positioning information of the goods carrying consignor terminal and the goods carrying consignee terminal;
sending the positioning information of the goods carrying consignor terminal to the goods carrying consignee terminal; and
sending the positioning information of the goods carrying consignee terminal to the goods carrying consignor terminal; and
wherein delivering the goods virtually between the goods carrying consignor terminal and the goods carrying consignee terminal on the basis of the association further comprises:
delivering the goods virtually between the goods carrying consignor terminal and the goods carrying consignee terminal according to the positioning information.

6. The method according to claim 1, wherein establishing the association between the goods carrying consignor terminal and the goods carrying consignee terminal further comprises:
acquiring network communication identities of the goods carrying consignor terminal and the goods carrying consignee terminal; and
establishing association between the network communication identity of the consignor terminal and the network communication identity of the goods carrying consignee terminal; and
wherein delivering the goods virtually between the consignor terminal and the goods carrying consignee terminal on the basis of the association further comprises:
delivering the goods virtually between the consignor terminal and the goods carrying consignee terminal on the basis of the association between the network communication identities.

7. The method according to claim 1, wherein delivering the goods virtually between the goods carrying consignor terminal and the goods carrying consignee terminal on the basis of the association further comprises:
receiving a prompt that the vehicle arrives at a delivery place or a receipt place within a first predetermined time, sent by the goods carrying consignee terminal, on the basis of the association; and
sending the prompt to the consignor terminal to prompt a user of the consignor terminal to arrive at the delivery place or the receipt place in time.

8. The method according to claim 1, wherein after establishing the association between the goods carrying consignor terminal and the goods carrying consignee terminal, the method further comprises:
determining whether the journey of the vehicle begins;
sending a request of handover before journey to the goods carrying consignee terminal according to a request of the consignor terminal when determining that the journey of the vehicle does not begin; and
receiving a reply to the request of handover before journey by the goods carrying consignee terminal;
wherein delivering the goods virtually between the goods carrying consignor terminal and the goods carrying consignee terminal on the basis of the association comprises:
allowing the goods carrying consignor terminal and the goods carrying consignee terminal to hand over the goods before the journey begins according to the request of handover before journey and the reply.

9. A goods carrying method, applicable to a goods carrying consignee terminal, comprising:
acquiring at least one goods carrying request through a passenger vehicle reservation server;
selecting and receiving a goods carrying request from the at least one goods carrying request;
receiving association information sent by the passenger vehicle reservation server, through the association information, association between the goods carrying consignee terminal and a goods carrying consignor terminal sending the goods carrying request is established; and
delivering goods virtually with the goods carrying consignor terminal sending the goods carrying request on the basis of the association information.

10. The method according to claim 9, wherein the consignee terminal comprises at least one passenger terminal that reserves passenger vehicles.

11. The method according to claim 9, wherein delivering the goods virtually with the consignor terminal sending the goods carrying request on a basis of the association information comprises:
determining a time of arriving at a delivery place of the vehicle according to vehicle speed of the vehicle and the delivery place information; and
sending prompt information to the consignor terminal when the time is within a first predetermined range.

12. The method according to claim 11, wherein goods transportation is canceled when the consignee terminal arrives at the delivery place at an agreed delivery time, but the consignor terminal does not arrive at the delivery place within a second predetermined time from the delivery time.

13. The method according to claim 9, wherein after establishing the association with the consignor terminal of the goods carrying request, the method further comprises:
setting a route of a navigation system of the vehicle as passing through a delivery place and/or a receipt place.

14. The method according to claim 9, further comprising:
sending a handover completion message to a passenger vehicle reservation server after goods handover is completed; and/or
sending the handover completion message to the goods carrying consignor terminal after goods handover is completed.

15. A goods carrying method, applicable to a goods carrying consignor terminal, comprising:
sending at least one goods carrying request to a passenger vehicle reservation server;
receiving a reply message to the goods carrying request from the passenger vehicle reservation server, and the reply message includes information of a consignee terminal that receives the goods carrying request;
receiving association information sent by the passenger vehicle reservation server, through the association information, association between the goods carrying consignor terminal and the goods carrying consignee terminal that receives the goods carrying request is established; and
delivering goods virtually with the consignee terminal of the goods carrying request on the basis of the association information.

16. A passenger vehicle reservation server, comprising: a memory and a processor,
wherein, the memory stores instructions, when the processor loads and executes the instruction, the goods carrying method according to claim 1 is executed.

17. A goods carrying consignee terminal, comprising: a memory and a processor,
wherein, the memory stores instructions, when the processor loads and executes the instruction, the goods carrying method according to claim 9 is executed.

18. A goods carrying consignor terminal, comprising: a memory and a processor,
wherein, the memory stores instructions, when the processor loads and executes the instruction, the goods carrying method according to claim 15 is executed.

19. A computer-executable nonvolatile storage medium, which stores computer program instructions, when a processor of a computer loads and executes the instructions, the goods carrying method according to claim 1 is executed.
